(19) United States
(12) Patent Application Publication
(10) Pub. No.: US 2023/0358323 A1
(43) Pub. Date: Nov. 9, 2023

(54) Valve Core Assembly and Reversing Valve with Valve Core Assembly

(71) Applicant: ZHEJIANG DUNAN ARTIFICIAL ENVIRONMENT CO., LTD., Shaoxing, Zhejiang (CN)

(72) Inventors: Fei ZHANG, Shaoxing, Zhejiang (CN); Feilong DU, Shaoxing, Zhejiang (CN); Jiafeng ZHU, Shaoxing, Zhejiang (CN)

(21) Appl. No.: 18/021,814

(22) PCT Filed: Aug. 11, 2021
(86) PCT No.: PCT/CN2021/112125

§ 371 Date: Feb. 17, 2023

(30) Foreign Application Priority Data
Aug. 20, 2020 (CN) 202010844928.3
Aug. 20, 2020 (CN) 202021756472.7
Dec. 31, 2020 (CN) 202011635625.7
Dec. 31, 2020 (CN) 202023340807.X

(51) Int. Cl. F16K 27/04; F16K 11/065

(52) U.S. Cl. CPC F16K 11/0655; F16K 27/044

(57) ABSTRACT

A valve core assembly and a reversing valve with the valve core assembly. The valve core assembly comprises: a guide frame (10); and a sliding block (20), wherein the guide frame (10) is in drive connection with the sliding block (20), one side of the sliding block (20) is provided with a cavity, the other side of the sliding block (20) is provided with a blocking portion (30), and the blocking portion (30) is used to block an inlet passage. The technical solution can solve the problem in the related art that reversing failure of a reversing valve easily occurs.

### CROSS-REFERENCE TO RELATED APPLICATION

The present disclosure claims priority to the following patent applications:
(1) the priority claim of patent application No. 202010844928.3, filed to the China National Intellectual Property Administration on Aug. 20, 2020 and entitled “Valve Core Assembly and Reversing Valve with Valve Core Assembly”;
(2) the priority claim of patent application No. 202021756472.7, filed to the China National Intellectual Property Administration on Aug. 20, 2020 and entitled “Valve Core Assembly and Reversing Valve with Valve Core Assembly”;
(3) the priority claim of patent application No. 202011635625.7, filed to the China National Intellectual Property Administration on Dec. 31, 2020 and entitled “Reversing Valve”; and
(4) the priority claim of patent application No. 202023340807.X, filed to the China National Intellectual Property Administration on Dec. 31, 2020 and entitled “Reversing Valve”.

### TECHNICAL FIELD

The present disclosure relates to a technical field of reversing valves, and in particular, to a valve core assembly and a reversing valve with the valve core assembly.

### BACKGROUND

As shown in FIG. 1, the existing four-way valve structure mainly comprises a valve cavity, and an inlet pipeline 2, a first outlet pipeline 3 and a second outlet pipeline 4 which are in communication with the valve cavity; a sliding block 1 is movably provided in the valve cavity; and by moving the sliding block 1, the valve cavity can be in communication with the first outlet pipeline 3 or in communication with the second outlet pipeline 4. In a reversing process, when the sliding block 1 moves to a middle position, the first outlet pipeline 3, the second outlet pipeline 4 and a low-pressure pipeline are in communication with one another, causing quick pressure relief in the valve cavity and insufficient pressure supply of a capillary pipe in communication with the inlet pipeline 2, such that the thrusts on left and right sides of a piston baffle are reduced, and in severe cases, a situation that the sliding block 1 stops in the middle and cannot continue to move may occur, resulting in working failure of the four-way valve.

### SUMMARY

Some embodiments of the present disclosure provide a valve core assembly and a reversing valve with the valve core assembly, so as to solve the problem in the related art that reversing failure of a reversing valve easily occurs.

According to one aspect of some embodiments of the present disclosure, provided is a valve core assembly, the valve core assembly comprising: a guide frame; and a sliding block, wherein the guide frame is in drive connection with the sliding block, one side of the sliding block is provided with a cavity, the other side of the sliding block is provided with a blocking portion, and the blocking portion is used to block an inlet passage.

Further, the surface of the blocking portion close to the inlet passage is an arc-shaped structure.

Further, the surface of the blocking portion close to the inlet passage is a planar structure.

Further, the blocking portion and the sliding block are an integrally formed structure.

Further, the blocking portion has a top surface and a bottom surface opposite each other, the top surface of the blocking portion is used to block the inlet passage, the bottom surface of the blocking portion is an arc-shaped surface, the bottom surface matches the upper surface of the sliding block, and the bottom surface of the blocking portion is connected with the sliding block.

Further, the guide frame is provided with an avoidance hole, and the sliding block passes through the avoidance hole.

Further, the sliding block comprises a main body and a bottom plate, the main body has a cavity, the blocking portion is arranged at the top of the main body, the bottom plate is annularly arranged at the bottom of the main body, the bottom plate cooperates with the avoidance hole to limit the relative position of the sliding block and the guide frame, the bottom plate is located at one side of the guide frame, and the blocking portion is located at the other side of the guide frame.

According to another aspect of some embodiments of the present disclosure, a reversing valve, the reversing valve comprising: a valve body, the valve body having an inlet passage, a plurality of outlet passages, and a chamber, the inlet passage and the outlet passages being all in communication with the chamber; and a valve core assembly, wherein the valve core assembly is the valve core assembly as provided above, the valve core assembly is movably provided in the chamber, and the side of a sliding block of the valve core assembly provided with a cavity is arranged toward the plurality of outlet passages, the side of the sliding block provided with a blocking portion is arranged toward the inlet passage, and the blocking portion has a blocking position for blocking the inlet passage and a communicating position for communicating the inlet passage.

Further, the valve body has two outlet passages and a low-pressure passage, the two outlet passages and the low-pressure passage are arranged side by side on one side of the valve body, the inlet passage is arranged on the other side of the valve body, and the low-pressure passage is located between the two outlet passages, the inlet passage is arranged corresponding to the low-pressure passage, and the blocking portion is located in the middle of the sliding block.

Further, the sectional dimension of the blocking portion is greater than or equal to the dimension of the inlet passage.

Further, the sectional dimension of the blocking portion is smaller than the dimension of the inlet passage.

Further, the side of the valve core assembly facing the plurality of outlet passages is a first side, the side of the valve core assembly facing the inlet passage is a second side, and the cross-sectional area of the inlet passage is S1, when the valve core assembly is located below the inlet passage, an exhaust passage is formed between the projection of an end of the inlet passage on the second side of the valve core assembly and the end of the inlet passage, and the side wall area of the exhaust passage is S2, S1/S2≥1.

Further, the exhaust passage is formed between the projection of the end of the inlet passage on the blocking portion and the end of the inlet passage.

Further, the blocking portion is a shielding boss, and the shielding boss is arranged on the side of the sliding block facing the inlet passage.

Further, a part of surface of the sliding block facing the inlet passage forms the blocking portion.

Further, the diameter of the inlet passage is d, the cross-sectional area S1 of the inlet passage is equal to π·(d/2)², the distance between the projection of an end of the inlet passage on the second side of the valve core assembly and the end of the inlet passage is X, and the side wall area S2 of the exhaust passage is equal to π·d·X.

By applying the technical solution of the present disclosure, the valve core assembly comprises a guide frame and a sliding block, wherein the sliding block is in drive connection with the guide frame, a blocking portion is provided at one side of the sliding block, and the blocking portion is used to block the inlet passage; then, when the sliding block moves to a middle position, the inlet passage is blocked by the blocking portion, to ensure that fluid with a sufficient pressure in the inlet passage flows into a capillary pipe in communication with the inlet passage, and further it can be ensured that sufficient pressure pushes a piston to continue to move, so that the sliding block moves to a reversing position. By means of the described structure, the occurrence of the situation in which the sliding block stops in a reversing process can be avoided, thereby ensuring normal reversing.

### BRIEF DESCRIPTION OF THE DRAWINGS

The drawings of the description, constituting a part of some embodiments of the present disclosure, are used for providing further understanding of some embodiments of the present disclosure, and the illustrative embodiments of some embodiments of the present disclosure and illustrations thereof are used to explain some embodiments of the present disclosure, rather than constitute inappropriate limitation on some embodiments of the present disclosure. In the drawings:

FIG. 1 shows a schematic structural diagram of a reversing valve provided in the related art;

FIG. 2 shows a schematic structural diagram of a reversing valve provided according to embodiments of the present disclosure;

FIG. 3 shows another schematic structural diagram of a reversing valve provided according to embodiments of the present disclosure;

FIG. 4 shows a schematic structural diagram of a first embodiment of a sliding block in FIG. 2;

FIG. 5 shows a schematic structural diagram of a second embodiment of a sliding block in FIG. 2;

FIG. 6 shows a schematic structural diagram of a blocking portion provided according to embodiments of the present disclosure;

FIG. 7 shows a schematic structural diagram of a reversing valve provided according to a third embodiment of the present disclosure;

FIG. 8 shows a partial sectional view of a reversing valve provided according to the third embodiment of the present disclosure;

FIG. 9 shows a schematic diagram of the dimension of a reversing valve provided according to the third embodiment of the present disclosure; and

FIG. 10 shows a partial sectional view of a reversing valve provided according to a fourth embodiment of the present disclosure.

The drawings comprise the following reference signs:
1. Sliding block; 2. Inlet pipeline; 3. First outlet pipeline; 4. Second outlet pipeline;
10. Guide frame; 20. Sliding block; 21. Main body; 22. Bottom plate; 30. Blocking portion; 40. Valve body; 41. Inlet passage; 42. Outlet passage; 43. Low-pressure passage; 44. Chamber;
50. Valve core assembly; 60. Exhaust passage; d. Diameter of inlet passage; X. Distance between the projection of an end of the inlet passage on a second side of the valve core assembly and the end of the inlet passage.

### DETAILED DESCRIPTION OF THE EMBODIMENTS

Hereinafter, the technical solutions in embodiments of the present disclosure will be described clearly and thoroughly with reference to the accompanying drawings of the embodiments of the present disclosure. Obviously, the embodiments as described are only some of the embodiments of the present disclosure, and are not all of the embodiments of the present disclosure. The following description of at least one exemplary embodiment is merely illustrative in nature and is in no way intended to limit some embodiments of the present disclosure and any applications or uses thereof. All other embodiments obtained by a person of ordinary skill in the art on the basis of the embodiments of the present disclosure without any inventive effort shall all fall within the scope of protection of some embodiments of the present disclosure.

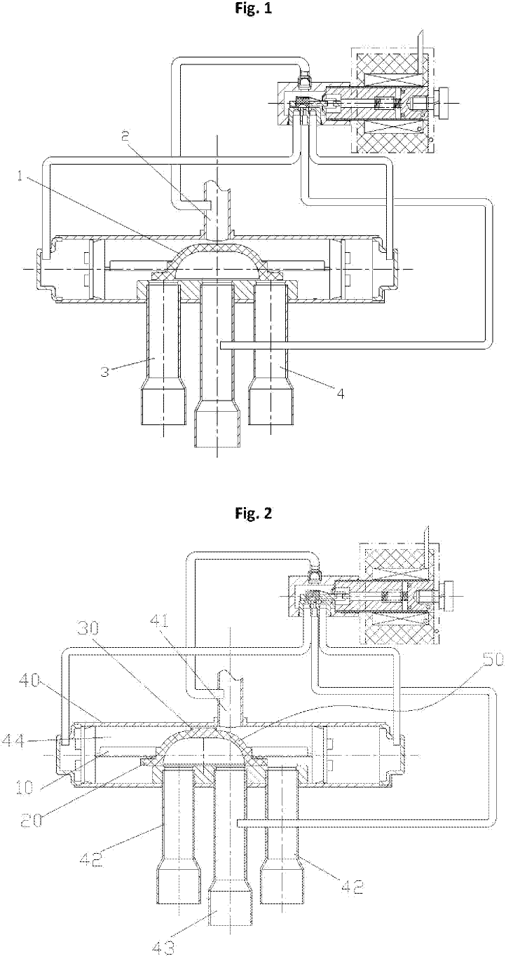

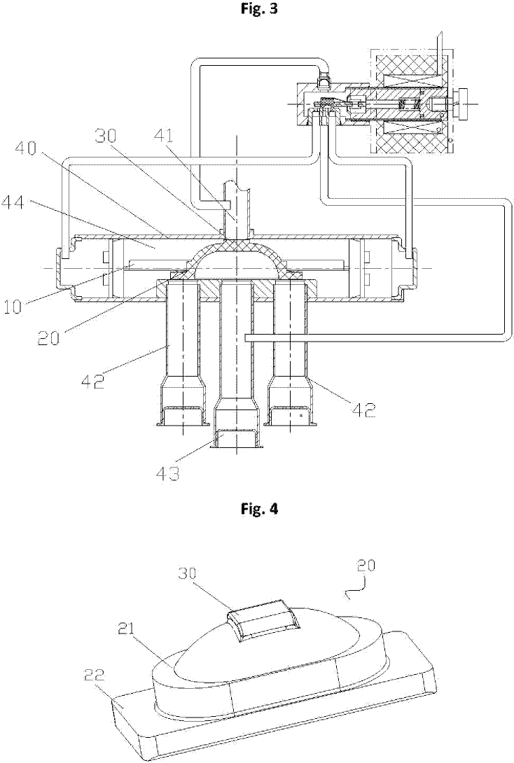

As shown in FIGS. 2 and 3, a first embodiment of the present disclosure provides a valve core assembly. The valve core assembly comprises: a guide frame 10 and a sliding block 20. The guide frame 10 is in drive connection with the sliding block 20, and the guide frame 10 is used for driving the sliding block 20 to move in a valve cavity. One side of the sliding block 20 is provided with a cavity, the other side of the sliding block 20 is provided with a blocking portion 30, and the blocking portion 30 is used to block an inlet passage. The cavity is used to isolate a part of outlet passages, such that fluid flows out of a specific outlet passage.

By means of the technical solution provided in the present disclosure, in a movement and reversing process, the sliding block 20 can block the inlet passage by using the blocking portion 30, so that when the outlet passages are in communication with each other, it can also be ensured that the inlet passage provides sufficient fluid pressure to a capillary pipe, and then it can be ensured that a piston of a reversing valve pushes the guide frame 10 and the sliding block 20 to continue to move to a preset position, thereby ensuring normal passage reserving.

As shown in FIG. 4, the surface of the blocking portion 30 close to the inlet passage may be of a planar structure, and by means of such an arrangement, the structure thereof is simple and the machining and manufacturing cost is low.

As shown in FIG. 5, the surface of the blocking portion 30 close to the inlet passage can also be set as an arc-shaped structure. By setting the blocking portion 30 as an arc-shaped structure, the arc-shaped structure can be better attached to an end of the inlet passage, so as to improve the blocking effect.

Specifically, the dimension of the blocking portion 30 can be greater than the dimension of the end of the inlet passage, and can also be set to be equal to the dimension of the end of the inlet passage, and can also be smaller than the dimension of the end of the inlet passage, as long as the blocking portion 30 can block and hinder the fluid of the inlet passage when moving to a position at the end of the inlet passage, thereby ensuring the fluid pressure of the capillary pipe in communication with the inlet passage.

In the structures as shown in FIGS. 4 and 5, the blocking portion 30 and the sliding block 20 are an integrally formed structure, and the structure thereof is simple, facilitating machining and mounting, and being able to increase the mounting efficiency.

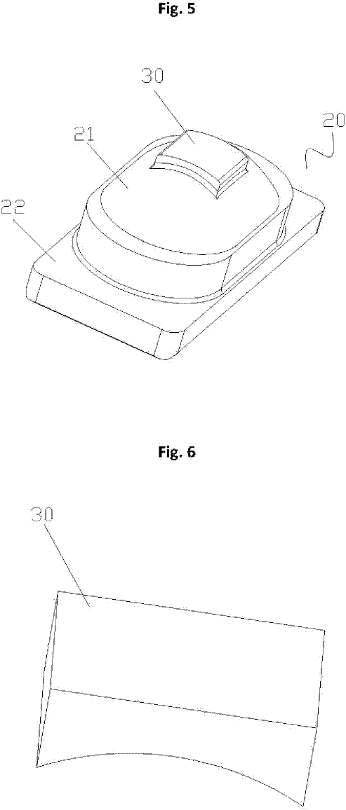

Of course, the blocking portion 30 and the sliding block 20 can also be provided as a split structure. As shown in FIG. 6, the blocking portion 30 has a top surface and a bottom surface opposite each other, the top surface of the blocking portion 30 is used for blocking the inlet passage, and the top surface thereof may be a flat surface or an arc-shaped surface. The bottom surface of the blocking portion 30 is an arc-shaped surface, the bottom surface matches the upper surface of the sliding block 20, and the bottom surface of the blocking portion 30 is connected with the sliding block 20. In particular, the connection can be performed by adhesion, welding or other connection manners. By means of the described structure, the structure of an apparatus can be simplified, facilitating machining of the sliding block 20 and the blocking portion 30, increasing the machining efficiency, and reducing the machining costs for components and parts.

In some embodiments of the present disclosure, the guide frame 10 is provided with an avoidance hole, and the sliding block 20 passes through the avoidance hole. By means of the described structure, the sliding block 20 is fixed in the guide frame 10 in a penetrating manner, one end of the sliding block 20 is located at one side of the guide frame 10, and the other end of the sliding block 20 is located at the other side of the guide frame 10, so that the guide frame 10 drives the sliding block 20 to move transversely.

Specifically, the sliding block 20 comprises a main body 21 and a bottom plate 22, wherein the main body 21 has a cavity, the blocking portion 30 is arranged at the top of the main body 21, the bottom plate 22 is annularly arranged at the bottom of the main body 21, the bottom plate 22 cooperates with the avoidance hole to limit the relative position of the sliding block 20 and the guide frame 10, the bottom plate 22 is located at one side of the guide frame 10, and the blocking portion 30 is located at the other side of the guide frame 10. By providing the bottom plate 22, the wear resistance of the side of the sliding block 20 provided with a cavity can be improved, and the upper and lower positions of the guide frame 10 and the sliding block 20 can be limited by the bottom plate 22. The bottom plate 22 is covered on one side of the outlet passages, and the guide frame 10 drives the sliding block 20 to translate, so that the bottom plate 22 moves above the outlet passages.

As shown in FIGS. 2 and 3, a second embodiment of the present disclosure provides a reversing valve. The reversing valve comprises: a valve body 40 and a valve core assembly 50. The valve body 40 has an inlet passage 41, a plurality of outlet passages 42 and a chamber 44, and the inlet passage 41 and the outlet passages 42 are all in communication with the chamber 44. The valve core assembly 50 is the valve core assembly provided in the described embodiments, the valve core assembly 50 is movably provided in the chamber 44, the side of the sliding block 20 provided with a cavity is arranged toward the plurality of outlet passages 42, the side of the sliding block 20 provided with a blocking portion is arranged toward the inlet passage 41, and the blocking portion 30 has a blocking position for blocking the inlet passage 41 and a communicating position for communicating the inlet passage 41.

The sliding block 20 has multiple communication positions in the chamber 44, and when the sliding block 20 moves to one communication position, an outlet passage 42 corresponding to the sliding block 20 is in communication with the chamber 44, and the other outlet passage 42 is isolated from the chamber 44 by means of the sliding block 20. In the process of the sliding block 20 moving from one communication position to a next communication position, the inlet passage 41 can be blocked by the blocking portion 30, thereby avoiding the situation that the plurality of outlet passages are in communication with each other during the movement of the sliding block 20, and the inlet passage 41 supplies an insufficient pressure to a capillary pipe in communication with the inlet passage.

Specifically, in this embodiment, the valve body 40 has two outlet passages 42 and a low-pressure passage 43, the two outlet passages 42 and the low-pressure passage 43 are arranged side by side on one side of the valve body 40, the inlet passage 41 is arranged on the other side of the valve body 40, the low-pressure passage 43 is located between the two outlet passages 42, the inlet passage 41 is arranged corresponding to the low-pressure passage 43, and the blocking portion 30 is located in the middle of the sliding block 20.

The sectional dimension of the blocking portion 30 is greater than or equal to the dimension of the inlet passage 41, to completely block the inlet passage 41 by the blocking portion 30, thereby ensuring that the inlet passage 41 can introduce fluid into the capillary pipe when the inlet passage is blocked by the blocking portion 30, ensuring that pistons on two sides of the guide frame 10 are pushed by the fluid pressure to move, and further enabling the sliding block 20 to move to a preset position.

In this embodiment, the sliding block 20 has a first communication position and a second communication position opposite each other, and during the movement of the sliding block 20 between the first communication position and the second communication position, the blocking portion 30 can block the inlet passage 41. As shown in FIG. 2, at this time, the guide frame 10 and the sliding block 20 are located on the left side of the chamber 44, the inlet passage 41 is in communication with the right-side outlet passage 42, and the sliding block 20 is in the first communication position. When the guide frame 10 and the sliding block 20 need to move to the right side, by control of a pilot valve at an upper position, the fluid in the capillary pipe in communication with the inlet passage 41 can be introduced to the left side of the chamber 44, so that the fluid can push the piston to move to the right side. As shown in FIG. 3, when the sliding block 20 moves to the middle position, the two outlet passages 42 and the low-pressure passage 43 are in communication with one another, and at this time, the pressure in the chamber 44 is low; and by providing the blocking portion 30, when the sliding block 20 moves to the middle, the inlet passage 41 is blocked by using the blocking portion 30, which can prevent the fluid in the inlet passage 41 from leaking into the chamber 44. In this way, all fluid in the inlet passage 41 can flow to the left side of the chamber 44, which ensures that the fluid has sufficient pressure to push the left-side piston to continue to move to the right, so that the guide frame 10 and the sliding block 20 can be driven to continue to move to the right, such that the cavity of the sliding block 20 is covered on the low-pressure passage 43 and the right-side outlet passage 42, and the left-side outlet passage 42 is in communication with the inlet passage 41, and at this time, the sliding block 20 is located at the second communication position, and the valve body completes a reversing operation.

The technical solution provided in some embodiments of the present disclosure achieves a simple structure, facilitates manufacturing and machining, can avoid the situation of reversing failure of the valve body, and can ensure that the valve body can operate normally.

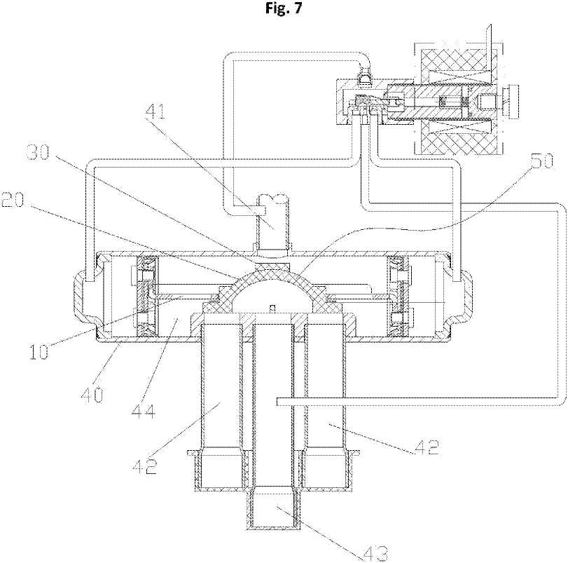

As shown in FIGS. 7-9, a third embodiment of the present disclosure provides a reversing valve. The reversing valve comprises a valve body 40 and a valve core assembly 50; the valve body 40 has a chamber 44, an inlet passage 41 and multiple outlet passages 42, wherein the inlet passage 41 and the outlet passages 42 are all in communication with the chamber 44, and the valve core assembly 50 is movably provided in the chamber 44. A first side of the valve core assembly 50 is arranged toward the multiple outlet passages 42, a second side of the valve core assembly 50 is arranged toward the inlet passage 41, and in the process of the valve core assembly 50 moving in the chamber 44, the valve core assembly 50 can be used to switch communication states between the multiple outlet passages 42 and the chamber 44. The cross-sectional area of the inlet passage 41 is S1, and when the valve core assembly 50 is located below the inlet passage 41, an exhaust passage 60 is formed between the projection of an end of the inlet passage 41 on the second side of the valve core assembly 50 and the end of the inlet passage 41, and the side wall area of the exhaust passage 60 is S2, S1/S2≥1.

By using the reversing valve provided in this embodiment, a ratio of S1 to S2 is set to be in the range above, and when the valve core assembly 50 moves to a middle position, it can be ensured that a fluid with a sufficient pressure in the inlet passage 41 flows into a capillary pipe in communication with the inlet passage 41, and further it can be ensured that sufficient pressure pushes the valve core assembly 50 to continue to move, so that the valve core assembly 50 moves to a reversing position. By means of the described structure, the occurrence of the situation in which the sliding block stops in a reversing process can be avoided, thereby ensuring normal reversing.

It should be noted that in this embodiment, the exhaust passage 60 refers to a cylindrical passage enclosed by the projection of the end of the inlet passage 41 on the second side of the valve core assembly 50 together with the end of the inlet passage 41, and the fluid in the inlet passage 41 may flow into the chamber 44 through the side wall of the cylindrical passage.

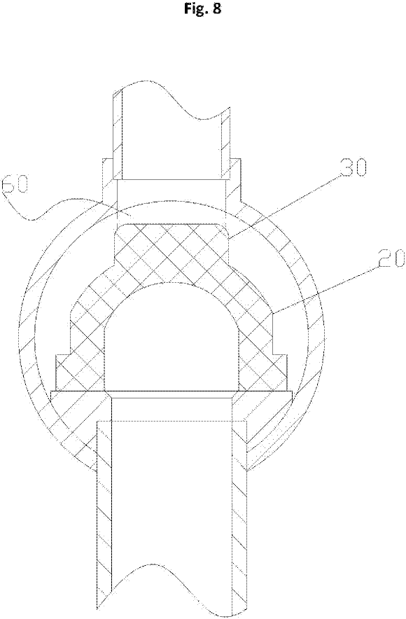

As shown in FIGS. 7 and 8, the second side of the valve core assembly 50 has a blocking portion 30, and an exhaust passage 60 is formed between the projection of the end of the inlet passage 41 on the blocking portion 30 and the end of the inlet passage 41. In a movement and reversing process, the valve core assembly 50 can block a part of the inlet passage 41 by using the blocking portion 30, so that when the outlet passages are in communication with each other, it can also be ensured that the inlet passage provides sufficient fluid pressure to a capillary pipe. Thus, it can be ensured that a piston of the reversing valve pushes the valve core assembly 50 to continue to move to a preset position, thereby ensuring normal passage reversing.

The blocking portion 30 comprises a structure integrally formed with the valve core assembly 50, and the blocking portion 30 further comprises a structure provided separately from the valve core assembly 50.

Specifically, the surface of the blocking portion 30 close to the inlet passage 41 has an arc-shaped structure or a planar structure. In this embodiment, the surface of the blocking portion 30 close to the inlet passage 41 is a planar structure, which facilitates calculation of the side wall area of the exhaust passage 60, and further facilitates control of the ratio of S1 to S2. Furthermore, the planar structure has a simple structure and low machining and manufacturing cost.

In other embodiments, the surface of the blocking portion 30 close to the inlet passage 41 may be set to be an arc-shaped structure. As the end of the inlet passage 41 is also arc-shaped, the arc-shaped structure can be used to better match the end of the inlet passage, so as to improve the shielding effect.

As shown in FIG. 7, in this embodiment, the valve core assembly 50 comprises a guide frame 10 and a sliding block 20, the guide frame 10 is in drive connection with the sliding block 20, and the blocking portion 30 is provided on the sliding block 20. The guide frame 10 can be used to drive the sliding block 20 to move in the chamber 44, and the sliding block 20 can be used to switch the communication state between the plurality of outlet passages 42 and the chamber 44. The blocking portion 30 is provided on the sliding block 20, facilitating machining of the blocking portion 30, and being able to reduce the machining cost.

Specifically, when the valve core assembly 50 moves to the middle position, the blocking portion 30 on the sliding block 20 can be used to shield the air inlet area of a part of the inlet passage 41, which can not only reduce the mass flow rate of a refrigerant leaked when the sliding block 20 is at the middle position, but also can force the refrigerant to enter the capillary pipe in communication with the inlet passage 41, such that the pressure entering a left-end cavity or a right-end cavity can be increased, the thrust to a piston baffle is increased, and the sliding block 20 can achieve smooth reversing.

In this embodiment, the blocking portion 30 is a shielding boss which is provided on the side of the sliding block 20 facing the inlet passage 41. By means of providing the shielding boss, there is no need to make big improvement on the sliding block 20, facilitating the machining of the sliding block 20, and the improvement cost is low.

The surface of the shielding boss close to the inlet passage 41 is an arc-shaped structure or a planar structure.

In this embodiment, the blocking portion 30 and the sliding block 20 are an integrally formed structure, which facilitates machining and assembly, has low cost, and can increase the installation efficiency.

Of course, the blocking portion 30 and the sliding block 20 can also be provided as a split structure. The blocking portion 30 has a top surface and a bottom surface opposite each other, the top surface of the blocking portion 30 is used for shielding the inlet passage, and the top surface thereof may be a flat surface or an arc-shaped surface. The bottom surface of the blocking portion 30 is an arc-shaped surface, the bottom surface matches the upper surface of the sliding block 20, and the bottom surface of the blocking portion 30 is connected with the sliding block 20. In particular, the connection can be performed by adhesion, welding or other connection manners. By means of the described structure, the structure of an apparatus can be simplified, facilitating machining of the sliding block 20 and the blocking portion 30, increasing the machining efficiency, and reducing the machining costs for components and parts.

In this embodiment, the guide frame 10 is provided with an avoidance hole, and the sliding block 20 passes through the avoidance hole. By means of the described structure, the sliding block 20 is fixed in the guide frame 10 in a penetrating manner, one end of the sliding block 20 is located at one side of the guide frame 10, and the other end of the sliding block 20 is located at the other side of the guide frame 10, so that the guide frame 10 drives the sliding block 20 to move transversely.

The sliding block 20 has multiple communication positions in the chamber 44, and when the sliding block 20 moves to one communication position, an outlet passage 42 corresponding to the sliding block 20 is in communication with the chamber 44, and the other outlet passage 42 is isolated from the chamber 44 by means of the sliding block 20. In the process of the sliding block 20 moving from one communication position to a next communication position, the inlet passage 41 can be shielded by the blocking portion 30, thereby avoiding the situation that the plurality of outlet passages 42 are in communication with each other during the movement of the sliding block 20, and the inlet passage 41 supplies an insufficient pressure to a capillary pipe in communication with the inlet passage. In this embodiment, the sliding block 20 has a first communication position and a second communication position opposite each other, and during the movement of the sliding block 20 between the first communication position and the second communication position, the blocking portion 30 can shield the inlet passage 41.

As shown in FIG. 7, in this embodiment, the valve body 40 has a low-pressure passage 43 and two outlet passages 42, the low-pressure passage 43 and the two outlet passages 42 are arranged side by side on one side of the valve body 40, the inlet passage 41 is arranged on the other side of the valve body 40, the low-pressure passage 43 is located between the two outlet passages 42, the inlet passage 41 is arranged corresponding to the low-pressure passage 43, and the blocking portion 30 is located in the middle of the sliding block 20. The blocking portion 30 is arranged in the middle of the sliding block 20, facilitating machining of the sliding block 20, being able to ensure the machining precision, and further ensuring the shielding effect of the blocking portion 30.

As shown in FIG. 7, when the sliding block 20 moves to the middle position, the two outlet passages 42 and the low-pressure passage 43 are in communication with one another, and at this time, the pressure in the chamber 44 is low; and by providing the blocking portion 30, when the sliding block 20 moves to the middle, the inlet passage 41 is shielded by using the blocking portion 30, which can prevent or reduce the fluid in the inlet passage 41 from leaking into the chamber 44. In this way, the fluid in the inlet passage 41 can flow to the left side of the chamber 44, which ensures that the fluid has sufficient pressure to push the left-side piston to continue to move to the right, so that the guide frame 10 and the sliding block 20 can be driven to continue to move to the right, such that the cavity of the sliding block 20 is covered on the low-pressure passage 43 and the right-side outlet passage 42, and the left-side outlet passage 42 is in communication with the inlet passage 41, and at this time, the sliding block 20 is located at the second communication position, and the valve body completes a reversing operation.

The maximum sectional dimension of the blocking portion 30 is greater than or equal to the dimension of the inlet passage 41, and thus the shielding effect of the blocking portion 30 can be ensured, facilitating control of the ratio of S1 to S2.

Specifically, as long as the blocking portion 30 can shield the fluid of the inlet passage when moving to a position at the end of the inlet passage, thereby ensuring the fluid pressure of the capillary pipe in communication with the inlet passage.

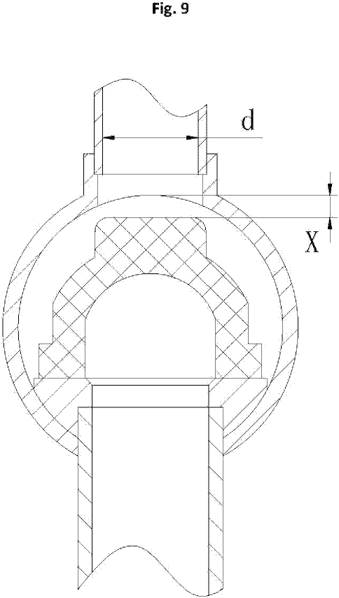

As shown in FIG. 9, in this embodiment, the inlet passage 41 is a circular passage, the diameter of the inlet passage 41 is d, the cross-sectional area S1 of the inlet passage 41 is equal to π·(d/2)², the distance between the projection of an end of the inlet passage 41 on the second side of the valve core assembly 50 and the end of the inlet passage 41 is X, and then the side wall area S2 of the exhaust passage 60 is equal to π·d·X.

In this embodiment, the reversing valve comprises an electromagnetic four-way reversing valve.

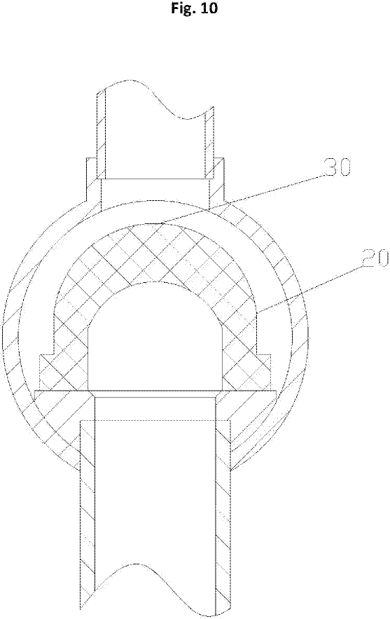

As shown in FIG. 10, a fourth embodiment of the present disclosure provides a reversing valve. The fourth embodiment differs from the third embodiment in that in the fourth embodiment, a part of surface of the sliding block 20 facing the inlet passage 41 forms the blocking portion 30. The upper surface of the sliding block 20 is used to form the blocking portion 30, and the sliding block 20 has a simple structure, thereby facilitating machining of the sliding block 20, and being able to reduce the machining costs.

The technical solution provided in some embodiments of the present disclosure achieves a simple structure, facilitates manufacturing and machining, can avoid the situation of reversing failure of the valve body, and can ensure that the valve body can operate normally.

The content above merely relates to preferred embodiments of the present disclosure and is not intended to limit some embodiments of the present disclosure. For a person skilled in the art, some embodiments of the present disclosure may have various modifications and variations. Any modifications, equivalent replacements, improvements, etc. made within the spirit and principle of some embodiments of the present disclosure shall all belong to the scope of protection of some embodiments of the present disclosure.

What is claimed is:

1. A valve core assembly, the valve core assembly comprising:
a guide frame (10); and
a sliding block (20), wherein the guide frame (10) is in drive connection with the sliding block (20), one side of the sliding block (20) is provided with a cavity, the other side of the sliding block (20) is provided with a blocking portion (30), and the blocking portion (30) is used to block an inlet passage.

2. The valve core assembly as claimed in claim 1, wherein a surface of the blocking portion (30) close to the inlet passage is an arc-shaped structure.

3. The valve core assembly as claimed in claim 1, wherein a surface of the blocking portion (30) close to the inlet passage is a planar structure.

4. The valve core assembly as claimed in claim 1, wherein the blocking portion (30) and the sliding block (20) are an integrally formed structure.

5. The valve core assembly as claimed in claim 1, wherein the blocking portion (30) has a top surface and a bottom surface opposite each other, the top surface of the blocking portion (30) is used to block the inlet passage, the bottom surface of the blocking portion is an arc-shaped surface, the bottom surface matches an upper surface of the sliding block (20), and the bottom surface of the blocking portion (30) is connected with the sliding block (20).

6. The valve core assembly as claimed in claim 1, wherein the guide frame (10) is provided with an avoidance hole, and the sliding block (20) passes through the avoidance hole.

7. The valve core assembly as claimed in claim 6, wherein the sliding block (20) comprises a main body (21) and a bottom plate (22), the main body (21) has a cavity, the blocking portion (30) is arranged at a top of the main body (21), the bottom plate (22) is annularly arranged at a bottom of the main body (21), the bottom plate (22) cooperates with the avoidance hole to limit a relative position of the sliding block (20) and the guide frame (10), the bottom plate (22) is located at one side of the guide frame (10), and the blocking portion (30) is located at the other side of the guide frame (10).

8. A reversing valve, the reversing valve comprising:
a valve body (40), the valve body having an inlet passage (41), a plurality of outlet passages (42), and a chamber (44), the inlet passage (41) and the outlet passages (42) being all in communication with the chamber (44); and
a valve core assembly (50), wherein the valve core assembly (50) is the valve core assembly as claimed in claim 1-7, the valve core assembly (50) is movably provided in the chamber (44), and a side of a sliding block (20) of the valve core assembly (50) provided with a cavity is arranged toward the plurality of outlet passages (42), a side of the sliding block (20) provided with a blocking portion is arranged toward the inlet passage (41), and the blocking portion (30) has a blocking position for blocking the inlet passage and a communicating position for communicating the inlet passage.

9. The reversing valve as claimed in claim 8, wherein the valve body (40) has two outlet passages (42) and a low-pressure passage (43), the two outlet passages (42) and the low-pressure passage (43) are arranged side by side on one side of the valve body (40), the inlet passage (41) is arranged on the other side of the valve body (40), and the low-pressure passage (43) is located between the two outlet passages (42), the inlet passage (41) is arranged corresponding to the low-pressure passage (43), and the blocking portion (30) is located in the middle of the sliding block (20).

10. The reversing valve as claimed in claim 8, wherein a sectional dimension of the blocking portion (30) is greater than or equal to a dimension of the inlet passage (41).

11. The reversing valve as claimed in claim 8, wherein a sectional dimension of the blocking portion (30) is smaller than a dimension of the inlet passage (41).

12. The reversing valve as claimed in claim 8, wherein a side of the valve core assembly (50) facing the plurality of outlet passages (42) is a first side, a side of the valve core assembly (50) facing the inlet passage (41) is a second side, and a cross-sectional area of the inlet passage (41) is S1, when the valve core assembly (50) is located below the inlet passage (41), an exhaust passage (60) is formed between a projection of an end of the inlet passage (41) on the second side of the valve core assembly (50) and the end of the inlet passage (41), and a side wall area of the exhaust passage (60) is S2, S1/S2≥1.

13. The reversing valve as claimed in claim 12, wherein the exhaust passage (60) is formed between a projection of the end of the inlet passage (41) on the blocking portion (30) and the end of the inlet passage (41).

14. The reversing valve as claimed in claim 13, wherein the blocking portion (30) is a shielding boss, and the shielding boss is arranged on a side of the sliding block (20) facing the inlet passage (41).

15. The reversing valve as claimed in claim 13, wherein a part of surface of the sliding block (20) facing the inlet passage (41) forms the blocking portion (30).

16. The reversing valve as claimed in claim 12, wherein a diameter of the inlet passage (41) is d, a cross-sectional area S1 of the inlet passage (41) is equal to π·(d/2)², a distance between the projection of the end of the inlet passage (41) on the second side of the valve core assembly (50) and the end of the inlet passage (41) is X, and a side wall area S2 of the exhaust passage (60) is equal to Π▪d▪X.

17. The reversing valve as claimed in claim 8, wherein a surface of the blocking portion (30) close to the inlet passage is an arc-shaped structure or a planar structure.

18. The reversing valve as claimed in claim 8, wherein the blocking portion (30) and the sliding block (20) are an integrally formed structure.

19. The reversing valve as claimed in claim 8, wherein the blocking portion (30) has a top surface and a bottom surface opposite each other, the top surface of the blocking portion (30) is used to block the inlet passage, the bottom surface of the blocking portion is an arc-shaped surface, the bottom surface matches an upper surface of the sliding block (20), and the bottom surface of the blocking portion (30) is connected with the sliding block (20).

20. The reversing valve as claimed in claim 8, wherein the guide frame (10) is provided with an avoidance hole, and the sliding block (20) passes through the avoidance hole.
